(19) United States
(12) Patent Application Publication
(10) Pub. No.: US 2026/0103551 A1
(43) Pub. Date: Apr. 16, 2026

(54) USE OF RADICAL SCAVENGERS TO REDUCE FOULING DURING HIGH PRESSURE POLYMERIZATION

(71) Applicant: Dow Global Technologies LLC, Midland, MI (US)

(72) Inventors: Sean W. Ewart, Pearland, TX (US); Alexander Williamson, Rosharon, TX (US); Ivan A. Konstantinov, Manvel, TX (US)

(73) Assignee: Dow Global Technologies LLC, Midland, MI (US)

(21) Appl. No.: 19/116,565

(22) PCT Filed: Sep. 27, 2023
(86) PCT No.: PCT/US2023/075203

§ 371 Date: Mar. 28, 2025

Related U.S. Application Data
(60) Provisional application No. 63/411,354, filed on Sep. 29, 2022.

(51) Int. Cl. C08F 10/02; C08F 2/00; C08F 2/38

(52) U.S. Cl. CPC C08F 10/02; C08F 2/005; C08F 2/38; C08F 2400/04; C08F 2500/08

(57) ABSTRACT

Embodiments of methods of producing high pressure ethylene-based polymer comprise polymerizing via free-radical polymerization at a pressure of at least 1000 atmospheres (atm) an ethylene monomer feed and optionally additional comonomer feed in the presence of radical scavenger to produce the high pressure ethylene-based polymer, wherein the radical scavenger comprises Structure 1: wherein: n can be 0 to 100; R₁, R₂ and R₃ are each independently H, (C₁-C₄₀)hydrocarbyl, (C₁-C₄₀)heterohydrocarbyl, or an aromatic containing moiety; and R₄-R₈ are each independently H, OH, (C₁-C₄₀)hydrocarbyl, (C₁-C₄₀)heterohydrocarbyl, or an aromatic containing moiety with the proviso that at least one of R₄-R₈ needs to be OH.

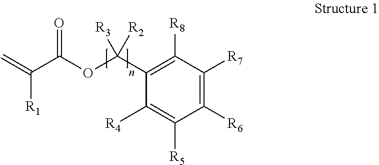

### CROSS-REFERENCE TO RELATED APPLICATIONS

This application claims the benefit of U.S. Provisional Application Ser. No. 63/411,354 filed Sep. 29, 2022, the entire disclosure of which is hereby incorporated herein by reference.

### TECHNICAL FIELD

Embodiments described herein generally relate to high pressure polymerization processes and specifically relate to the use of radical scavengers used to reduce fouling during high pressure polymerization.

### BACKGROUND

One of the major causes of reduced production rates in high pressure polymerization processes is fouling, for example, hypercompressor or preheater fouling. Accordingly, there is a need for an additive that eliminates reactor fouling but does not negatively impact the high pressure polymerization process or the product.

### SUMMARY

Embodiments of the present disclosure meet this need through the use of radical scavengers that can reduce the amount of fouling with no deleterious effects on the polymerization process or the product properties.

According to at least one embodiment of the present disclosure, a method of producing high pressure ethylene-based polymer is provided. The method comprise polymerizing via free-radical polymerization at a pressure of at least 1000 atmospheres (atm) an ethylene monomer feed and optionally additional comonomer feed in the presence of radical scavenger to produce the high pressure ethylene-based polymer, wherein the radical scavenger comprises Structure 1:

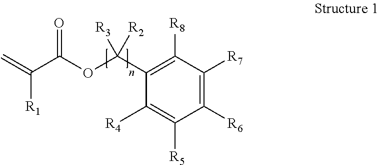

wherein: n can be 0 to 100; R₁, R₂ and R₃ are each independently H, (C₁-C₄₀)hydrocarbyl, (C₁-C₄₀)heterohydrocarbyl, or an aromatic containing moiety; and R₄-R₈ are each independently H, OH, (C₁-C₄₀)hydrocarbyl, (C₁-C₄₀)heterohydrocarbyl, or an aromatic containing moiety with the proviso that at least one of R₄-R₈ needs to be OH.

These and other embodiments are described in more detail in the following detailed description.

### DETAILED DESCRIPTION

Specific embodiments of the present application will now be described. These embodiments are provided so that this disclosure will be thorough and complete and will fully convey the scope of the subject matter to those skilled in the art.

The term “polymer” refers to a polymeric compound prepared by polymerizing monomers, whether of a same or a different type. The generic term polymer thus embraces the term “homopolymer.” which usually refers to a polymer prepared from only one type of monomer as well as “copolymer.” which refers to a polymer prepared from two or more different monomers. The term “interpolymer.” as used herein, refers to a polymer prepared by the polymerization of at least two different types of monomers. The generic term interpolymer thus includes a copolymer or polymer prepared from more than two different types of monomers, such as terpolymers.

“Polyethylene” or “ethylene-based polymer” shall mean polymers comprising greater than 50% by mole of units derived from ethylene monomer. This includes ethylene-based homopolymers or copolymers (meaning units derived from two or more comonomers). Common forms of ethylene-based polymers known in the art include, but are not limited to, Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). Ethylene based polymer also encompasses “ethylene acid copolymer”, which is a polymerized reaction product of ethylene and one or more unsaturated carboxylic acid containing monomers.

Embodiments are directed to a method of producing high pressure ethylene-based polymer comprising: polymerizing via free-radical polymerization at a pressure of at least 1000 atmospheres (atm) an ethylene monomer feed and optionally additional comonomer feed in the presence of radical scavenger to produce the high pressure ethylene-based polymer.

In embodiments, the high pressure ethylene-based polymer is an ethylene homopolymer such as low density polyethylene (LDPE). In other embodiments, the high pressure ethylene-based polymer is an ethylene copolymer comprising the polymerized reaction product of ethylene and polar comonomers. In further embodiments, the high pressure ethylene-based polymer is an ethylene acid copolymer comprising the polymerized reaction product of ethylene and carboxylic acid containing comonomer. The carboxylic acid containing comonomer may include unsaturated monocarboxylic acids such as acrylic acid, methacrylic acid, or combinations thereof. In embodiments, the unsaturated carboxylic acid containing comonomer may be present in an amount of from 5 wt. % to 35 wt. %, from 12 to 30 wt. %, from 15 wt. % to 25 wt. %, or from 21 wt. % to 25 wt. % based on a total weight of the monomers present in the ethylene acid copolymer. Conversely, the ethylene content of the ethylene acid copolymer is greater than 50 wt. %, or greater than 60 wt. %. For example, the ethylene content of the ethylene acid copolymer is from 50 wt. % to 95 wt. %, from 70 wt. % to 88 wt. %, from 75 wt. % to 85 wt. %, or from 75 wt. % to 79 wt. %.

In embodiments, the radical scavenger comprises Structure 1:

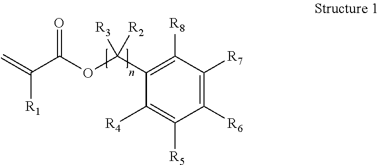

wherein: n can be 0 to 100; R₁, R₂ and R₃ are each independently H, (C₁-C₄₀)hydrocarbyl, (C₁-C₄₀)heterohydrocarbyl, or an aromatic containing moiety; and R₄-R₈ are each independently H, OH, (C₁-C₄₀)hydrocarbyl, (C₁-C₄₀)heterohydrocarbyl, or an aromatic containing moiety with the proviso that at least one of R₄-R₈ needs to be OH.

In further embodiments, n is from 0 to 10, or preferably is 0 to 5. In further embodiments. R₁ is a C₁-C₆ alkene, preferably C₁-C₃ alkene, or most preferably ethylene; and at least one of R₂ and R₃ is an aromatic containing moiety. In other embodiments, at least one of R₄-R₈ needs to be OH, and at least one of R₄-R₈ needs to be a C₁-C₆ hydrocarbyl.

In other embodiments, the radical scavenger comprises the following Structure 2

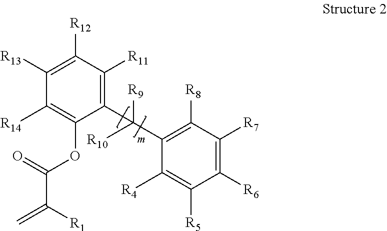

wherein: m can be from 0 to 100; R₁ is H, (C₁-C₄₀)hydrocarbyl, (C₁-C₄₀)heterohydrocarbyl, or an aromatic containing moiety; R₄-R₈ are each independently H, OH, (C₁-C₄₀)hydrocarbyl, (C₁-C₄₀)heterohydrocarbyl, or an aromatic containing moiety with the proviso that at least one of R₄-R₈ needs to be OH; R₉ and R₁₀ are each independently H, (C₁-C₄₀)hydrocarbyl, or (C₁-C₄₀)heterohydrocarbyl; and R₁₁-R₁₄ are each independently H, OH, (C₁-C₄₀)hydrocarbyl, (C₁-C₄₀)heterohydrocarbyl, or an aromatic containing moiety.

In other embodiments, m is from 0 to 10, or preferably from 0 to 5. In other embodiments, at least one of R₄-R₈ needs to be OH, and at least one of R₄-R₈ needs to be a C₁-C₆ hydrocarbyl. In further embodiments, at least one of R₉ and R₁₀ is an H or a C₁-C₆ hydrocarbyl, and at least one of R₁₁-R₁₄ is a C₁-C₆ hydrocarbyl.

In other embodiments, the radical scavenger comprises the following Structure 3

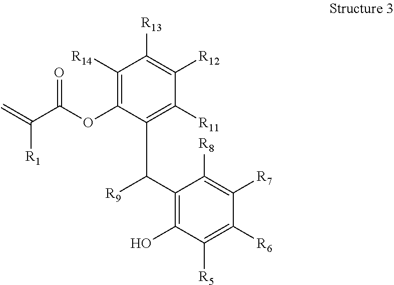

wherein: R₁ is independently H, (C₁-C₄₀)hydrocarbyl, (C₁-C₄₀)heterohydrocarbyl, or an aromatic containing moiety; R₅-R₈ are each independently H, OH, (C₁-C₄₀)hydrocarbyl, (C₁-C₄₀)heterohydrocarbyl, or an aromatic containing moiety; R₉ is H, (C₁-C₄₀)hydrocarbyl, or (C₁-C₄₀)heterohydrocarbyl; and R₁₁-R₁₄ are each independently H, OH, (C₁-C₄₀)hydrocarbyl, (C₁-C₄₀)heterohydrocarbyl, or an aromatic containing moiety.

In embodiments, at least one of R₅-R₈ and/or at least one of R₁₁-R₁₄ is either tert-butyl or tert-pentyl. In further embodiments, at least one of R₅-R₈ is tert-butyl, at least one of R₅-R₈ is methyl, or both conditions are met. In additional embodiments, at least one of R₁₁-R₁₄ is tert-butyl, at least one of R₁₁-R₁₄ is methyl, or both conditions are met. In further embodiments, at least one of R₅-R₈ is tert-pentyl. In additional embodiments, at least one of R₁₁-R₁₄ is tert-pentyl.

In specific embodiments, the radical scavenger comprises one or both of the following structures:

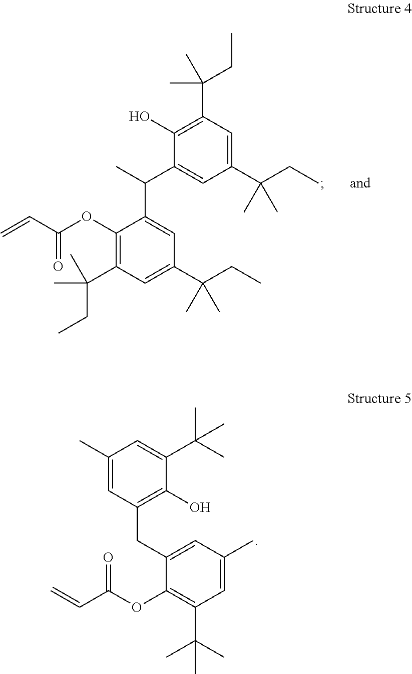

Various amounts are considered suitable for the radical scavenger. In embodiments, the radical scavenger is added at a concentration of 0.1 mol ppm to 5 ppm based on the amount of ethylene feed and optionally additional comonomer feed. In other embodiments, the radical scavenger is added at a concentration of 0.1 mol ppm to 1 ppm, or from 0.25 to 0.75 ppm based on the amount of ethylene feed and optionally additional comonomer feed.

Additional additives are also considered for the present process. For example, the polymerization may occur in the presence of a chain transfer agent. In embodiments, the chain transfer agent comprise aliphatic and olefinic hydrocarbons, ketones, aldehydes, and saturated aliphatic aldehyde alcohols. In one embodiment, the chain transfer agent comprises propionaldehyde.

The free radical polymerization process is generally known in the art. Generally the process is conducted at elevated temperatures and pressures in either a batch-wise process or continuous manner. Suitable reactors such as tubular reactors or autoclave reactors are familiar to the person of skill in the art. Additionally, compressor units upstream of the reactors and separator units downstream of the reactors are also familiar to the skilled person. The polymerization pressure may be in the range of at least 1000 atm (101.3 MPa or 1013.25 bar), from 1000 to 5000 atm, from 1200 to 4000 atm, or from 1500 to 3500 atm. The polymerization temperature is typically in the range of about 70° C. to about 380° C. All individual values and subranges in the range of about 70° C. to about 380° C. are included herein and disclosed herein; for example, polymerization temperature is in the range of 100° C. to 300° C. or from 150° C. to 250° C.

In one or more embodiments, the high pressure ethylene-based polymer further comprises from 1 to 100 ppm radical scavenger, from 10 to 100 ppm radical scavenger, or from 10 to 50 ppm based on the weight of the high pressure ethylene-based polymer.

### Test Methods

### Melt Index

Melt index was measured according to ASTM D 1238-13. Standard Test Method for Melt Flow Rates of Thermoplastics by Extrusion Plastometer, using conditions of 190° C./2.16 kilograms (kg). Results were reported in units of grams eluted per 10 minutes (g/10 min.) or the equivalent in decigrams per 1.0 minute (dg/1 min.).

### Total Dissolution Method

For this test, all samples used were in pellet form. About 1.0 g±0.02 g of resin was weighed into a clean 100 mL glass bottle and the weight was recorded. A PTFE-coated stirrer bar was added to the bottle. In the hood. 25 mL o-xylene was added to the bottle with an electronic pipette. The bottle was sealed with a crimp cap. The bottle was placed on the Gerstel robot, and the robot completed the sample preparation. The sample was dissolved by placing the bottle on the heat/stir plate for 30 min at 130° C. The solution was cooled on a 15-position stirrer for 15 minutes with mixing. After 15 minutes of cooling. 50 mL of isopropanol was added to the bottle. The solution was stirred again for two hours. The stirrer was turned off and the solid particles were allowed to settle. One mL of solution was removed and transferred to a 2-mL capped glass autosampler vial. The autosampler vials were placed in the LC autosampler for analysis. The samples and standard solutions are analyzed using a reversed phase liquid chromatographic method with a UV/Vis absorbance detector. Concentrations in extracts were determined using an external standard calibration procedure.

### EXAMPLES

The following examples illustrate features of the present disclosure but are not intended to limit the scope of the disclosure.

### Example 1—Reactor Fouling Tests

### Comparative Examples C1 and C2

In a 300 ml continuous reactor, ethylene was added at 7 lb/hr along with propionaldehyde at 1000 mol ppm and both were pressurized to 30.000 psi through the use of a compressor and a valve. The reactor was heated to 100° C. (C1) or 140° C. (C2) to mimic the temperatures in the compressor and preheater portions of an LDPE plant. The ethylene and propionaldehyde were allowed to flow through the reactor at temperature for 18 hours. During the course of the 18 hours, all polymer formed was collected and weighed. At the end of the 18 hours, the reactor is opened and examined for level of fouling.

### Comparative Example C3 (BHT)

For Comparative Example C3, the same procedure was used as Comparative Example C2, but butylated hydroxytoluene (BHT) was added to the propionaldehyde to give a final BHT concentration in the reactor of 0.5 mol ppm. BHT is a hindered phenol antioxidant commonly used in the LDPE process but does not contain the (meth)acrylate substitution.

### Inventive Examples I1 and I2

For inventive examples I1 and I2, the same procedure was used as in the comparative examples except that Sumilizer GS (Structure 4) from Sumitomo Chemical was added to the propionaldehyde to give a final concentration in the reactor of 0.5 mol ppm. Reactor temperatures were 100° C. for I1 and 140° C. for I2.

Further as shown in Table 1 below, reactor fouling was measured for Comparative Examples C1-C3 and Inventive Examples 11-12. As shown, each reactor was evaluated and ranked from 1-5 with 1 being most fouled and 5 being completely clean. As shown below, the inventive samples I1 and I2 yielded reactors that were completely clean (11=ranking of 5) or clean (12=ranking of 5) and had very little polymer collected thereon, both of which indicate reduced fouling. In contrast, comparative samples C1 through C3 yielded reactors with fouling rankings of 1 to 3, respectively, with at least 3 times the amount of polymer collected on the reactor, all of which indicate increased fouling.

TABLE 1

| | | Reactor | Inhibitor | Polymer | |
|---|---|---|---|---|---|
| | | Temperature | level | collected | Fouling |
| Sample | Inhibitor | (° C.) | (mol ppm) | (lb) | (1-5) |
| C1 | None | 100 | 0 | 1.27 | 1 |
| | (comparative) | | | | |
| C2 | None | 140 | 0 | 0.78 | 2 |
| | (comparative) | | | | |
| C3 | BHT | 140 | 0.5 | 0.48 | 2 |
| | (comparative) | | | | |
| I1 | Sumilizer GS | 100 | 0.5 | 0.15 | 5 |
| | (Structure 4) | | | | |
| I2 | Sumilizer GS | 140 | 0.5 | 0.12 | 4 |
| | (Structure 4) | | | | |

### Example 2—Radical Scavenger Final Concentration

The following examples in Table 2 show how radical scavengers are present in the final polymer concentration. In a 300 ml continuous reactor, ethylene was added at 25 lb/hr along with propionaldehyde at approximately 400 mol ppm and both were pressurized to 28,000 psi through the use of a compressor and a valve. The reactor was heated to 270° C. and operated adiabatically. Tert-butyl peroxyacetate was added to produce 12% ethylene conversion in the reactor. Sumilizer GS was the radical scavenger added to the reactor as a solution in propionaldehyde at the levels shown in Table 2. In Table 2, Radical Scavenger Reactor Feed Concentration and Radical Scavenger Fed/Polymer Produced were measured based on mass balance from pilot plant data. The Radical Scavenger in Final Polymer form was measured by the Total Dissolution Method.

TABLE 2

| Run | A | B | C |
|---|---|---|---|
| Radical Scavenger Reactor Feed Concentration | 0.5 | 1.1 | 1.6 |
| (mol ppm) | | | |
| Radical Scavenger Fed/Polymer Produced (mass | 69 | 171 | 249 |
| ppm) | | | |
| Radical Scavenger in Final Polymer (mass ppm) | 14 | 26 | 38 |

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A method of producing high pressure ethylene-based polymer comprising:
polymerizing via free-radical polymerization at a pressure of at least 1000 atmospheres (atm) an ethylene monomer feed and optionally additional comonomer feed in the presence of radical scavenger to produce the high pressure ethylene-based polymer, wherein the radical scavenger comprises Structure 1: 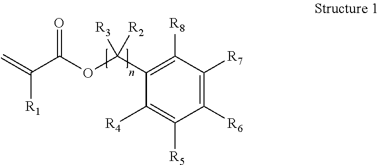
wherein: n is from 0 to 100; R₁, R₂ and R₃ are each independently H, (C₁-C₄₀)hydrocarbyl, (C₁-C₄₀)heterohydrocarbyl, or an aromatic containing moiety; and R₄-R₈ are each independently H, OH, (C₁-C₄₀)hydrocarbyl, (C₁-C₄₀)heterohydrocarbyl, or an aromatic containing moiety with the proviso that at least one of R₄-R₈ is OH.

2. The method of claim 1, wherein the radical scavenger comprises Structure 2 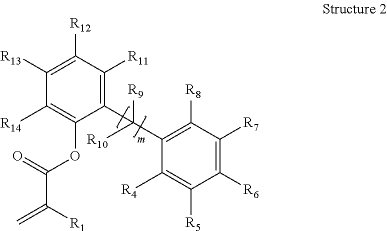
wherein: m is from 0 to 100; R₁ is H, (C₁-C₄₀)hydrocarbyl, (C₁-C₄₀)heterohydrocarbyl, or an aromatic containing moiety; R₄-R₈ are each independently H, OH, (C₁-C₄₀)hydrocarbyl, (C₁-C₄₀)heterohydrocarbyl, or an aromatic containing moiety with the proviso that at least one of R₄-R₈ is be OH; R₉ and R₁₀ are each independently H, (C₁-C₄₀)hydrocarbyl, or (C₁-C₄₀)heterohydrocarbyl; and R₁₁-R₁₄ are each independently H, OH, (C₁-C₄₀)hydrocarbyl, (C₁-C₄₀)heterohydrocarbyl, or an aromatic containing moiety.

3. The method of claim 1, wherein the radical scavenger comprises Structure 3 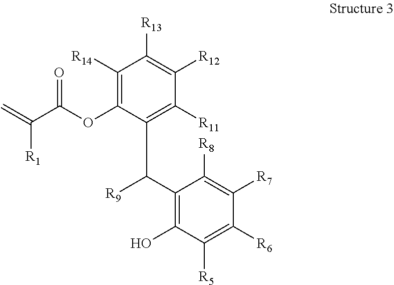
wherein: R₁ is independently H, (C₁-C₄₀)hydrocarbyl, (C₁-C₄₀)heterohydrocarbyl, or an aromatic containing moiety; R₅-R₈ are each independently H, OH, (C₁-C₄₀)hydrocarbyl, (C₁-C₄₀)heterohydrocarbyl, or an aromatic containing moiety; R₉ is H, (C₁-C₄₀)hydrocarbyl, or (C₁-C₄₀)heterohydrocarbyl; and R₁₁-R₁₄ are each independently H, OH, (C₁-C₄₀)hydrocarbyl, (C₁-C₄₀)heterohydrocarbyl, or an aromatic containing moiety.

4. The method of claim 1, wherein at least one of R₅-R₈ is tert-butyl or tert-pentyl.

5. The method of claim 1, wherein the radical scavenger comprises one or both of the following structures:

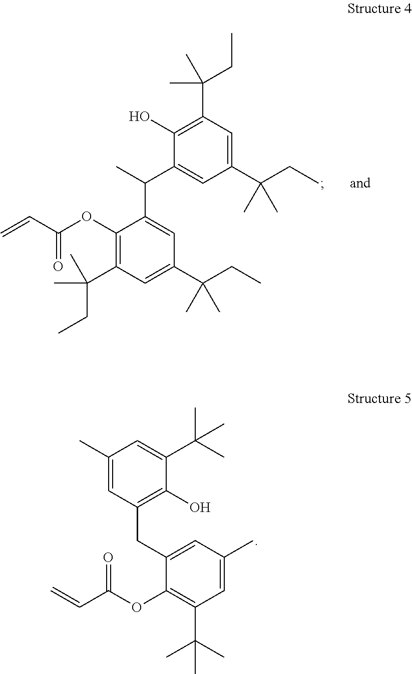

6. The method of claim 1, wherein the polymerization occurs in the presence of a chain transfer agent.

7. The method of claim 6, wherein the chain transfer agent comprises aliphatic hydrocarbons, olefinic hydrocarbons, ketones, aldehydes, or saturated aliphatic aldehyde alcohols.

8. The method of claim 6, wherein the chain transfer agent comprises propionaldehyde.

9-14. (canceled)

15. The method of claim 1, wherein the radical scavenger is added at a concentration of 0.1 mol ppm to 5 ppm based on the amount of ethylene feed and optionally additional comonomer feed.

16. The method of claim 1, wherein the additional comonomer comprises polar monomers.

17. The method of claim 1, wherein the high pressure ethylene-based polymer comprises low density polyethylene (LDPE).

18. A high pressure ethylene-based polymer produced by a method comprising:
polymerizing via free-radical polymerization at a pressure of greater than or equal to 1000 atmospheres (atm) an ethylene monomer feed or the ethylene monomer and an additional comonomer feed in the presence of radical scavenger to produce the high pressure ethylene-based polymer, wherein the radical scavenger comprises one or more of the following structures: 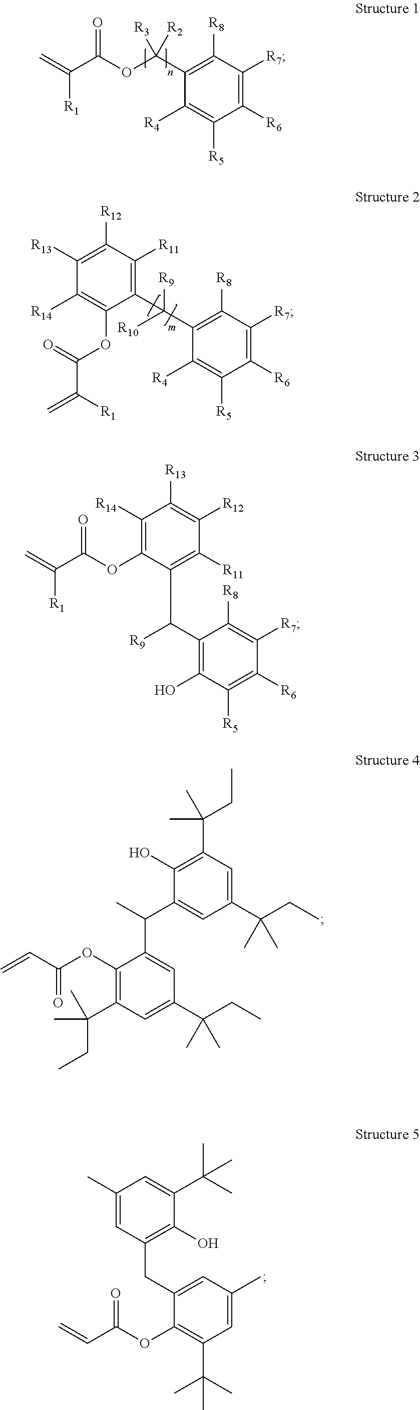
or combinations thereof;
wherein: n is from 0 to 100; m is from 0 to 100; R₁, R₂ and R₃ are each independently H, (C₁-C₄₀)hydrocarbyl, (C₁-C₄₀)heterohydrocarbyl, or an aromatic containing moiety; and R₄-R₈ are each independently H, OH, (C₁-C₄₀)hydrocarbyl, (C₁-C₄₀)heterohydrocarbyl, or an aromatic containing moiety with the proviso that at least one of R₄-R₈ is OH; R₉ and R₁₀ are each independently H, (C₁-C₄₀)hydrocarbyl, or (C₁-C₄₀)heterohydrocarbyl; and R₁₁-R₁₄ are each independently H, OH, (C₁-C₄₀)hydrocarbyl, (C₁-C₄₀)heterohydrocarbyl, or an aromatic containing moiety.

19. The high pressure ethylene-based polymer of claim 18 wherein the high pressure ethylene-based polymer further comprises from 1 to 100 ppm radical scavenger based on the weight of the high pressure ethylene-based polymer.

20. The method of claim 2, wherein at least one of R₅-R₈ is tert-butyl or tert-pentyl; or at least one of R₁₁-R₁₄ is tert-butyl or tert-pentyl; or at least one of R₅-R₈ and at least one of R₁₁-R₁₄ are either tert-butyl or tert-pentyl.

21. The method of claim 3, wherein at least one of R₅-R₈ is either tert-butyl or tert-pentyl; or at least one of R₁₁-R₁₄ is either tert-butyl or tert-pentyl; or at least one of R₅-R₈ and at least one of R₁₁-R₁₄ are either tert-butyl or tert-pentyl.

22. The method of claim 1, wherein the high pressure ethylene-based polymer comprises an ethylene acid copolymer comprising the polymerized reaction product of ethylene and carboxylic acid containing comonomer.

23. The method of claim 22, wherein the carboxylic acid containing comonomer comprises acrylic acids, methacrylic acids, or combinations thereof.

24. The high pressure ethylene-based polymer of claim 18, comprising low density polyethylene (LDPE).

25. The high pressure ethylene-based polymer of claim 18, comprising an ethylene acid copolymer.

26. The high pressure ethylene-based polymer of claim 25, wherein the ethylene acid copolymer comprises a polymerized reaction product of ethylene and carboxylic acid containing comonomer, wherein the carboxylic acid containing comonomer comprises acrylic acids, methacrylic acids, or combinations thereof.
